(19) United States
(12) Patent Application Publication
(10) Pub. No.: US 2006/0192688 A1
(43) Pub. Date: Aug. 31, 2006

(54) Transponder hanger for rear view mirror assembly of vehicle

(76) Inventor: Thomas Thad Taylor, Miami, FL (US)

Correspondence Address: John C. Malloy, 100 Edgewater Dr 116, Miami, FL, 33133, US

(21) Appl. No.: 11/056,967

(22) Filed: Feb. 14, 2005

(51) Int. Cl. G08G 1/065; G08B 13/14

(52) U.S. Cl. 340/928; 340/572.8

(57) ABSTRACT

For a vehicle equipped with a transponder for recording the passage through a toll area by a vehicle without requiring the vehicle to stop in so passing, a transponder hanger to support the transponder on the conventional rear view mirror assembly which includes a hooked stem and a elongate lateral support portion with two spaced bands of elastic material in depending relation on the support portion adjacent the ends of the support portion to embrace the transponder about its periphery and the bands each being of a length, when stretched, within the elastic limit of the bands to hold, position and orient the transponder when embracing it.

### FIELD OF THE INVENTION

This invention relates to transponders for vehicles to permit easy passage through toll areas, and, more particularly, to a hanger for such transponders for hooked up attachment to a rear view mirror assembly of a vehicle.

### BACKGROUND OF THE INVENTION

In the past, at toll areas on expressways, there are often traffic delays because drivers are called upon to stop, select correct amounts of money, pay and, often, await a receipt. To speed up the process, baskets have been installed so that drivers, who do not require a receipt, can toss coins into the baskets in correct amount to obtain passage more rapidly and reduce lines. More recently, drivers have been provided with an electronic device, called a transponder, which sends a signal that is automatically received and charges an account established for the driver and automatically permits passage. Since the vehicle so equipped does not have to stop at all, this latter method has dramatically reduced lines and, with that, an added benefit occurs, namely, a significant fuel saving or reduction in cost for fuel, fuel that would otherwise be wasted during long waits in lines at toll areas.

In using this method, it is necessary to position the transponder on the driver's vehicle where it can “see” electronically and “pay” for passage. Most transponders are adhesively attached temporarily to the windshields of vehicles; but this adhesive often gives way, especially in response to heat load build up on windshields on hot days. When this happens, the transponder falls onto the dashboard and, often, to the floor. Also, when this has occurred, a driver must search for and locate it, reach to recover it and manually operate it, a messy and a “sticky” job for the one at the wheel. This type of event often defeats the purpose of the transponder, namely, reducing delays at toll areas. This invention overcomes these problems.

### SUMMARY OF THE INVENTION

The invention is of a hanger for the transponder and associated elements which cooperate to attain enhanced benefits of traffic transponders and avoidance of the problems that have persisted with growing transponder use including those mentioned above. This invention provides a hanger with transponder on it for hooked up engagement on a vehicle mirror assembly which includes a) a mounting means to attach it to the windshield of the vehicle, or adjacent to the windshield, b) a mirror frame with a mirror, and, c) an arm connecting the frame and mounting means. Specifically, the hanger comprising the invention is hooked over the arm between the mirror frame and the mounting means for the mirror assembly. Once installed thusly, it remains there for use in gaining rapid passage through a toll area of an expressway without having to stop the vehicle completely . . .

### OBJECTS OF THE INVENTION

To overcome the problems of transponder usage described above, and those well known to and apparent to users of traffic transponders, a general object of this invention is to provide a transponder hanger to position and orientate a transponder for rapid, automatic and convenient ease of use at traffic toll areas, and which is inexpensive to manufacture, which accommodates a wide range of transponder sizes of various manufacturers, which is easily installed, and is well adapted for the purposes set forth and apparent from this disclosure.

Safety is promoted by this invention at relatively rapid moving lines at toll stations because, instead of a need to search about the interior of a vehicle in order to find a transponder which has fallen to the floor, the vehicle can pass through the toll zone without disrupting the traffic stream.

In accord with these and other objects expressed and implied herein, the instant invention will be described on reference to the accompanying illustrations in which:

### DESCRIPTION OF THE DRAWING ILLUSTRATIONS OF THE INVENTION

FIG. 1 is an illustration of an installed transponder and hanger on a vehicle.

FIG. 2 is an illustration of a preferred embodiment of the hanger.

### DESCRIPTION OF PREFERRED EMBODIMENTS

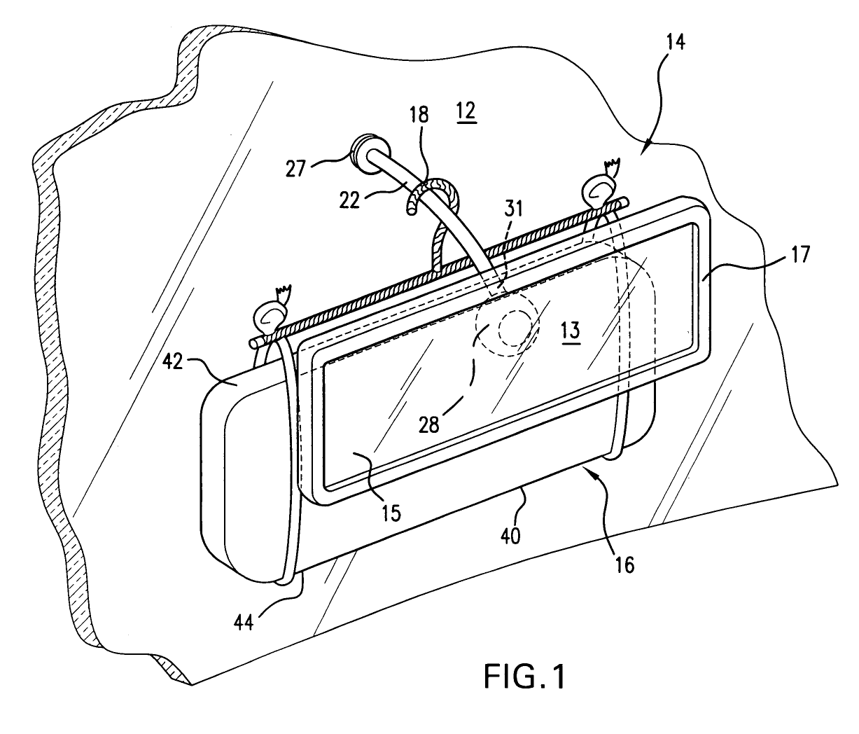

Referring to FIG. 1, there is represented the windshield 12 of a vehicle equipped with a rear view mirror assembly 14, often found mounted on the windshield. The mirror 13 in the mirror frame 17 of the assembly 14 has a reflective main face 15 and an opposite non-reflective frame face. The reflective main face 15 is positioned so as to be visible to a driver in the driver seat in the vehicle. The mirror, of course, is for viewing toward the rear of the vehicle. The mirror assembly 14 is suitably installed on the vehicle, either, directly to the windshield, or it may be otherwise connected suitably to the vehicle adjacent the windshield 12. This connection means, or base, which may be of any suitable structure, is designated by the numeral 27.

The transponder 16 is carried in elastic bands 86 and 88 depending from a hanger 18 which in turn is connected to the mirror assembly 14 in hooked up relation over the arm 22 between the mirror base and the mirror frame 17.

The hanger 18 is attached, removably in hooked up relation, on the mirror assembly 14 between its mounting 27 to the vehicle and its connection 28 to the mirror frame 17 on an arm 22. The end 31 of the arm 22 is provided with the connection means 28, ordinarily a type which permits a range of mirror frame adjustment to vary the view seen through the mirror.

The transponder 16 is composed of a housing 40 for the electronic device; and it has an upper lateral surface 42, a lower surface 44, opposite end surfaces 46 and 48 and a front surface 50 and a rear surface.

The hanger 18 is composed of a lateral member or portion 54, a stem portion 52 and a hook portion 54. The lateral member or portion 54 has an upper surface 56, a first end zone 58 and a second end zone 60 with a central zone 62 there between. The stem portion extends generally perpendicularly from the central zone to a distal end zone 65, which is hook shaped and defines a) a distal most support portion 67, b) a first side portion 69 connecting the support portion and the lateral portion, and c) a second side portion 70 extending from the support portion to a terminal end 72 spaced from the elongate portion forming an open mouth 73 for hooked up engagement over the arm 22 of the mirror assembly 14. In each of the end zones 58 and 60 of the lateral portion of the hanger, there is a through recess, see 81 and 82, which receives an elastic band 86 or 88. Thus, the bands are restrained from moving out of their positions on the lateral portion of the hanger. Each band has a normal relaxed length and is of elastic material. Further it is characterized by an elastic limit greater than the periphery of the transponder and a relaxed length less than the periphery of it.

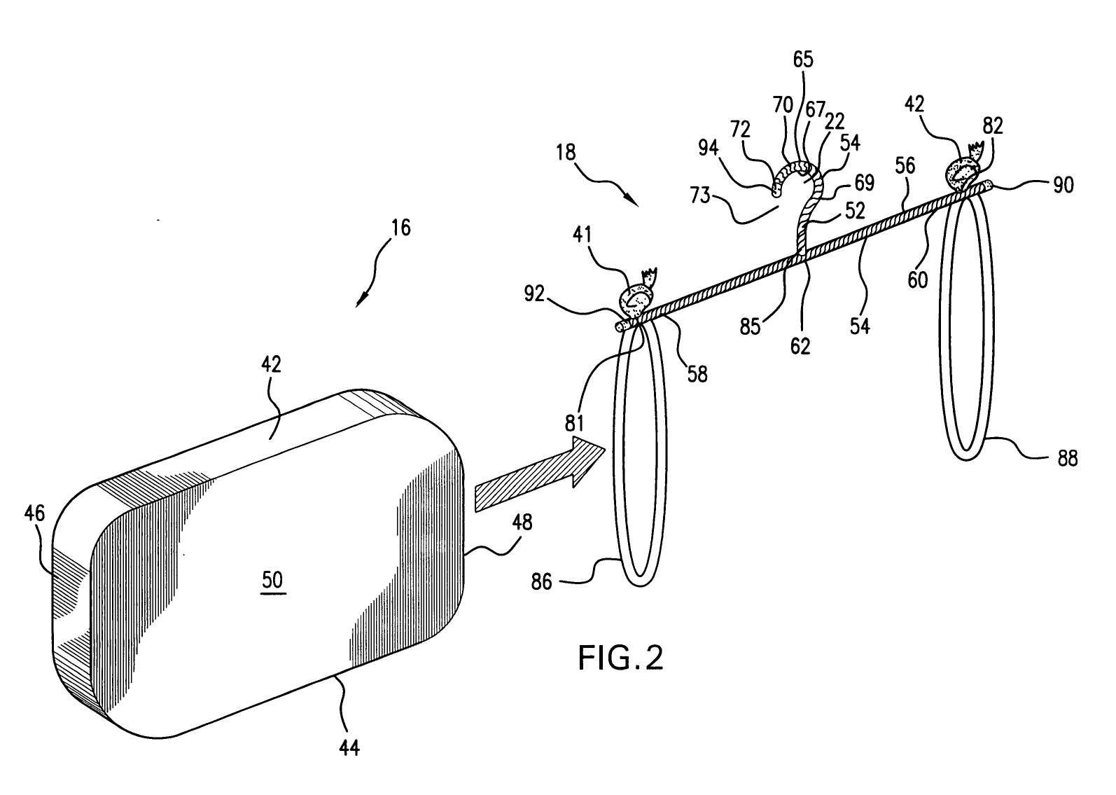

The hanger may be of twisted wire with terminal ends which are tipped as at 90, 92 and 94, with plastic material, see FIG. 2. As also seen in FIG. 2, the recesses 81 and 82 are closed tight about the elastic loops about the bands 86 and 88. Each of the bands constitutes an elastic length, which after passage of the ends of the length through the recess, either 81 or 82, are tied off forming a knot 41,42 larger than the passage provided through the recesses. Finally, the stem portion of the hanger may be in the shape of a dogleg bend 85 around the lateral portion 54; and the zone adjacent the terminal end 72 of the second side portion 70 may be out turned.

Alternatively, the hanger may be of a one piece molded plastic article.

In use, the transponder is positioned in the stretched bands and then the hanger is hooked over the arm of the mirror assembly between the mirror mounting means and the mirror frame.

In a preferred embodiment the hanger is of twisted wire strands although this is not necessary. The overall height of the stem is such that in combination with the loops which fit about the body of the transponder housing, which is ordinarily of plastic in the rigid range, presents the lower portion facing in a forward direction to “see” its target in its line of sight.

While this invention has been shown and described in the practical and preferred foregoing embodiments, it is recognized that departures may be made within the spirit and scope of the invention which is not therefore intended to be limited except by the following claims and within the doctrine of equivalents.

What is claimed is:

1. For a vehicle, a transponder, a transponder hanger, and a rear view mirror assembly, in combination, for attachment and detachment of the hanger to the a rear view mirror assembly adjacent the non-reflective surface of the mirror assembly,
said assembly including, a mirror frame, a mirror in the frame having the non-reflective surface and an opposite reflective surface, mounting means to attach the assembly to the vehicle, and an arm portion connecting the frame and mounting means,
said transponder hanger comprising
an elongate lateral support member, said support member having
an upper surface, a first end zone, a second end zone, and a central zone intermediate the end zones,
a stem extending away from the central portion in a first direction with a distal end zone,
said distal zone being hook shaped having a
a distal most support portion,
a first side portion extending between the support portion and the support portion, and
a second side portion spaced from the first side portion and extending from the support portion to a terminal end spaced from the stem forming an open mouth for hooked up engagement over the arm,
a first elastic band on the first end zone and a second elastic band on the second end zone, and each of said bands being of a relaxed normal length stretchable within their elastic limits to a length sufficient to snugly embrace the transponder housing to hold, position and orient the transponder for use.

2. A hanger as set forth in claim 1 wherein the hanger includes means to maintain the position of the transponder on the hanger between the bands and member.

3. The hanger asset forth in claim 2 wherein a recess is provided in the each of the zones of the the member each captivating one of the bands and restraining movement of the bands from lateral movement relative to the member. when about a transponder.

4. A transponder hanger as set forth on claim 1 wherein the support member is an integral article.

5. For a transponder a, transponder hanger including a lateral support portion with an upper surface, a first end zone, a second end zone, and a central zone there between, a stem extending from the central zone having a hooked distal end spaced from the support portion, a first and a second elastic band, each band being of normal length and stretchable within their elastic limits to snugly embrace the transponder to hold, position and orient the transponder for use in passing a toll area.
